(19) United States
(12) Patent Application Publication
(10) Pub. No.: US 2004/0225562 A1
(43) Pub. Date: Nov. 11, 2004

(54) Method of maximizing revenue from performance-based internet advertising agreements

(75) Inventor: Brenton Russell Turner, Seattle, WA (US)

Correspondence Address: LANGLOTZ PATENT WORKS, INC., PO BOX 759, GENOA, NV, 89411, US

(73) Assignee: aQuantive, Inc.

(21) Appl. No.: 10/435,235

(22) Filed: May 9, 2003

(51) Int. Cl. G06F 17/60

(52) U.S. Cl. 705/14

(57) ABSTRACT

A method of determining the placement of a plurality of different Internet advertisements at a plurality of different Internet publisher websites sites each having an advertisement placement space. For each user visiting a publisher website, an impression of an advertisement is served. Initial web browsing activity data is recorded for each impression served. Subsequent action data associated with the service of the impression is recorded. The subsequent action data is associated with the initial web browsing activity data to generate an effectiveness level for the combinations of advertisements and placement spaces. Based on the generated effectiveness levels, serving of the advertisements is distributed among the placement spaces.

### FIELD OF THE INVENTION

This invention relates to Internet communication, and more particularly to analytical, technical, and informational tools for optimizing the effectiveness of Internet advertising tactics.

### BACKGROUND AND SUMMARY OF THE INVENTION

Many companies use the Internet for advertising. Typically, companies place electronic images and/or text (ads) on Web sites in order to promote their brands, images, goods, and/or services. Companies that own web sites (publishers) create spaces on their web sites (placements) specifically to be sold to companies wishing to advertise (advertisers).

To perform advertising, an advertiser creates ads that appropriately communicate desired advertising messaging. The advertiser designs the ads such that, if users select or “click” on them, the users' browsers request a Web page of the advertiser's choosing, often to enable the user to transact with the advertiser. The advertiser then selects appropriate sites on the Internet on which to place these ads, and contracts with the publishers of these sites in order to purchase rights to advertise on them. Typically, a publisher has many different placements within the site that are available for advertising, and the advertiser selects preferable placements for its ads.

Publishers quantify advertising inventory through the term “impressions.” When a user visits a publisher's web site, each time the user's browser downloads a page within the site, he/she creates a “page-view.” When a user's browser downloads a page that has a placement reserved for advertising (placement), he/she creates an impression, or an opportunity to view an advertisement. Therefore, by way of example, if a given web site has 1000 page-views per week, and each page has two advertising placements, then the publisher has an inventory of 2000 weekly impressions.

Pricing for advertising can be broadly divided into two categories. The first is impression-based pricing, wherein the publisher sells an advertiser a number of impressions in a given time period. Impression-based pricing is typically done on a CPM basis, meaning cost per 1000 impressions.

Although publishers prefer impression-based pricing, market forces often prevent them from successfully selling all of their inventories under this structure. In general, the Internet advertising market sees a constant over-supply of impressions, given the accompanying demand. Therefore, on a monthly basis, most publishers have between 15% and 70% of impressions that cannot be sold through CPM pricing.

This market dynamic gives rise to a second pricing approach called performance-based pricing. Under this model, the publisher provides impressions for free, and the advertiser agrees to pay the publisher based on the success of the impressions in causing valuable advertiser results. This agreement structure is known as a “performance deal.” Typical examples of performance deals include cost-per-click, where the advertiser pays a bounty each time a user clicks on its advertisement; cost-per-sale, where the advertiser pays a bounty each time a user clicks on an advertisement on the publisher's site and subsequently makes a purchase on the advertiser's Web site; and cost-per-registration, where the advertiser pays a bounty each time a user clicks on the advertiser's banner on the publisher's site, and subsequently completes a registration page or e-mail submission on the advertiser's site. Many permutations of these structures exist.

Publishers measure the value of performance deals by effective CPM (eCPM). The eCPM is calculated by multiplying the revenue generated from a particular deal by 1000, and dividing the product by the impressions required to generate the revenue. By way of example, if a publisher granted a particular deal 1,000,000 impressions, generated 50 valuable transactions, and the advertiser agreed to pay $50 per transaction, the deal's eCPM would be calculated by: 50*50*1000/1,000,000=$2.50. The eCPM provides a useful metric for appraising the effectiveness of performance deals, and for comparing the value of performance deals with impression-based deals. eCPM calculations are also useful for comparing the revenue-generating capability of different advertising placements within a given Web site.

However, there are two broad factors that make performance deals unattractive to a typical publisher.

The first factor is the publisher's assumption of the risk of the deals' performance in generating valuable actions, with little negotiating leverage to work with. Although the quality of the publisher's placements and audience are significant factors that determine the performance of advertisements on the publisher's Web site, other important factors such as the visual appeal of the advertiser's ads, the attractiveness of the advertiser's offering, and the smoothness of the transaction flow on the advertisers' Web sites are out of the publisher's control. Moreover, suboptimal performance on the advertiser's part on any of these dimensions translates directly to lost revenues for the publisher, while the publisher is largely unable to affect the outcome.

More often than not, these risks translate directly into realities for publishers who strike performance deals. The eCPMs generated by performance deals can be very low, when compared to impression-based deals. For example, a publisher that charges a $2.00 CPM for impression-based advertising agreements might find that its performance deals only return $0.20 eCPM.

Moreover, Publishers have very poor negotiating leverage when striking performance deals. Most advertisers have an internal cost-per-transaction requirement that they manage and maintain as a part of their advertising programs. Any advertising agreements that can meet or beat this requirement are beneficial for the advertiser. Advertisers are keenly aware that market dynamics have forced publishers into performance deals, and that the publisher's only alternative to striking performance deals is lost revenues. Therefore, advertisers are often able to secure performance deals for bounties-per-transaction that are much lower than their cost-per-transaction requirement. For example, an advertiser maintaining an internal cost-per-sale goal of $100 may be able to secure a performance deal for $10 per transaction, simply because of market forces, and the publisher has little negotiating leverage to require a larger bounty.

The second factor is the lack of tools to help publishers efficiently and effectively manage performance deals. The typical publisher has no technology for tracking valuable actions such as sales or registrations that occur on the advertiser's site and tying them back to exposure to advertisements on the publisher's site. Instead, publishers rely on the advertiser's software to link a user's “click” on an advertisement on the publisher's Web site to sales or registrations that the advertiser is willing to pay for.

This dependence on the advertiser's software creates seven major problems for the publisher. First, the publisher must depend on the advertiser's diligence in returning transaction data in order to determine the revenue levels that the agreement has generated. Therefore, a publisher often devotes significant levels of inventory to each performance deal before understanding whether the agreement is worth continuing.

Second, because most advertiser software is not designed to support “delayed click-transactions” to advertising, the publisher is not able to include them in performance deals. Often the bulk of transactions that take place after a user “clicks” are delayed, meaning that after users “click,” they use their initial visit to the advertiser's Web site to develop knowledge of the advertiser's offering, but do not transact immediately. Instead, they return at some later date in order to execute a transaction. However, most advertiser software only supports session-based responses, meaning that a user transacts immediately after a “click.” Because session-based responses are only a small subset of all transactions on the advertiser's site that occur after a “click,” the publisher is unable to monetize a large percentage of the transaction that the advertising on its Web site causes.

Third, because most advertiser software is not designed to support “view-based transactions” to advertising, either immediate or delayed, the publisher is also unable to include them in performance deals. Research has shown that a user's “click” is not the sole predictor of whether or not advertising caused the user's transaction. Instead, some users respond to advertising without a “click,” by submitting the advertiser's URL to the user's browser, and transacting immediately or at some later date. Therefore, publishers can argue that advertisements placed on their Web sites drive some number of transactions that occur without a “click.” However, because no advertiser software is designed to attribute transactions that occur without a “click” to advertising views on the publisher's Web site, the publisher is unable to monetize them as a part of performance deals.

Fourth, the tools available to the typical publisher for optimizing the effectiveness of its advertising inventory in driving valuable transactions are quite rudimentary. When measured in aggregate across all of a publisher's advertising inventories, almost all performance deals are poor generators of revenue. This is largely because, for each specific advertiser, those placements on the publisher's Web site that are effective (often very effective) in driving valuable transactions are mixed with a larger number of placements that are very ineffective in the aggregate calculation. For example, out of 100 placements, an advertiser might generate a $2.00 eCPM on 10 placements, but only generate a $0.05 eCPM on the other 90, yielding an aggregate $0.245 eCPM.

Further, the placements that are most effective in generating valuable transactions are not the same for every deal. In the previous example, the 90 placements that generate an $0.05 eCPM for the deal in question might generate a $2.00 eCPM for another deal, or a set of deals. Therefore, the opportunity exists for the publisher to extract more value from each advertising placement by allocating inventories on each placement to deals that are most effective on the placement.

However, few publisher tools exist to make these allocations possible. For example, when the advertiser returns transaction data to the publisher, reflecting those transactions that were caused by the publisher's advertising inventory, the publisher has little ability to tie these transactions to the specific inventories that caused them. Moreover, in cases where the publisher is able to tie transactions to placements for some advertisers, the publisher's ability to make informed comparisons across advertising agreements, in order to determine which deal should receive more impressions, is very limited. Therefore, most publishers simply make continue/cancel decisions on performance deals after measuring their effectiveness in aggregate, sacrificing the value available through more granular allocation of impressions to deals on a placement-by-placement basis.

Fifth, because publishers are not able to optimize inventories, advertisers are often dissatisfied with the volume of transactions generated by their performance deals. Although advertisers prefer performance deals because of their guarantee of tangible results and limited risk exposure, poor transaction volume generated by most performance deals often translates to dissatisfaction for the advertiser. Further, because the publisher has few tools for allocating inventories to advertisers whose ads are most effective; advertisers are continually frustrated with the outcome of performance deals.

Sixth, most publishers have access to little information that is useful in determining which placements within the publisher's Web site are most valuable in generating valuable advertiser transactions. Without this information, they are largely unable to make important adjustments/improvements to their advertising inventories, or to cancel inventory whose performance is unacceptable and cannot be improved.

Seventh, the absence of effective tools makes the execution and management of performance deals very onerous and resource-consuming. Publishers devote significant personnel and resources toward campaign setup and implementation, data transfers with the publishers, reconciliation of errors, and accounting. Moreover, given the effectiveness of the tools used by those managing the deals, and the limited top-line revenues generated by performance deals, most publishers realize very little bottom-line profits.

The present invention overcomes the two broad factors that make performance deals unattractive for publishers.

First, it provides valuable analytical and technical tools for managing performance deals effectively. The invention enables publishers to efficiently tie valuable advertiser transactions to the advertising placements within their Web sites that caused them, with very little involvement on the part of the advertiser. Further, it supports both session-based and delayed responses to advertising, as well as responses that happen after ad exposure, but in the absence of a “click,” so that publishers can monetize much more of the advertising value that their inventories generate. The invention also enables the publisher to optimize its advertising inventories by dynamically allocating placement inventories to advertisers for whom the inventories are most effective, and therefore generate the most revenue for the publisher. Finally, the invention provides the publisher with critical information on the relative performance of advertising placements, to enable the publisher to continually improve the performance of its advertising inventories by improving existing inventories and retiring those that cannot be improved.

Second, the invention returns critical negotiating leverage to the publisher by enabling it to create an optimization-powered auction environment for its advertising inventories. Because the publisher is able to allocate inventories to advertisers whose performance is superior to others, those advertisers that perform poorly on most of the publisher's placements lose inventory allocations, and therefore transaction volumes. The invention provides the advertiser with information on changes the advertiser can make to its agreement structure, including raising the bounty it is willing to pay for each transaction the publisher's inventory generates, in order to improve the deal's effectiveness, meriting more advertising inventories for the advertiser, and generating more revenue for the publisher. By providing similar information to every advertiser, the publisher creates an optimization-powered auction for its advertising inventories, wherein each advertiser bears the risk of the performance of its respective deal, and constantly improves it in order to merit advertising inventories.

### BRIEF DESCRIPTION OF THE DRAWINGS

FIG. 1 is a schematic block diagram showing the system and environment in which a preferred embodiment of the invention operates.

FIG. 2 is flow chart showing the operation of the system according the preferred embodiment of the invention.

### DETAILED DESCRIPTION OF A PREFERRED EMBODIMENT

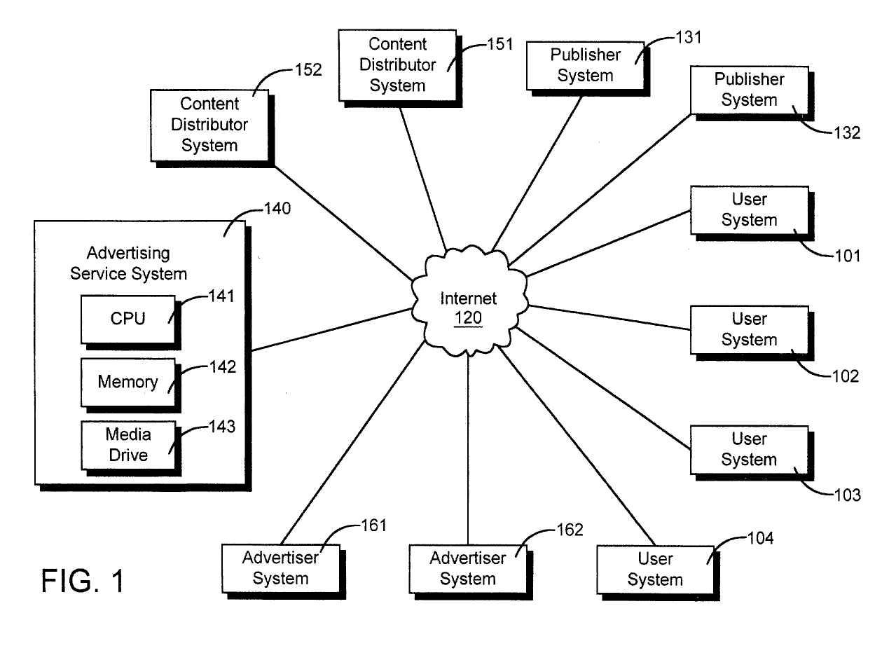

FIG. 1 is a high-level block diagram showing the environment in which the facility preferably operates. The diagram shows a number of Internet customer or user computer systems 101-104. An Internet customer preferably uses one such Internet customer computer system to connect, via the Internet 120, to an Internet publisher content system, such as Internet Publisher Content Systems 131 and 132, to retrieve and display a Web page. This is generally referred to “web browsing,” and may include non-commercial activity as well as commercial activity such as retail purchases. Content Distributor Systems Publisher advertising systems (Content Distributor Systems) 151, 152 and advertiser systems 161 and 162, and Third-Party Ad Servers (TPAS) 140 communicate via the Internet to serve advertisements placed on publisher web sites to users visiting those sites.

Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities.

The preferred embodiment (optimization system) operates in conjunction (or is built “on top”) of a TPAS. The TPAS preferably includes one or more central processing units (CPUs) 141 for executing computer program such as the facility, a computer memory 142 for storing programs and data, and a computer-readable media drive 143, such as a CD-ROM drive, for reading programs and data stored on a computer-readable medium. The optimization system preferably includes one or more CPU's, computer memory, database and Internet software packages, and an off-the-shelf linear programming software, such as Dash Optimization Software.

Further, while preferred embodiments are described in terms of the environment outlined above, those skilled in the art will appreciate that the facility may be implemented in a variety of other environments, including a single, monolithic computer system, as well as various other combinations of computer systems or similar devices.

When a user's Internet browser requests one of a publisher's Web pages from a publisher content system, the page may include one or more advertising placements. In these cases, the page forwards the request(s) for one or more advertising messages to fill the placement(s) on the web page to the publisher advertising system. Upon receiving the request(s), the publisher advertising system determines whether or not to serve advertising message(s) from the advertisers with whom the publisher it has made agreements other than performance deals. If not, the publisher advertising system forwards the request(s) to the TPAS. The impression is considered “performance inventory.”

Every time the TPAS ad server receives a request for an advertising message, it records the anonymous cookie number of the requesting browser. If the browser does not have an TPAS cookie, the TPAS places a cookie on the requesting browser's computer system, and encodes it with a unique, anonymous number. Currently, over 95% of the computer systems whose users browse the Internet have a TPAS cookie.

Each request is accompanied by several pieces of data that the TPAS uses to determine which ad to transmit in response to the request. These pieces of data can be broadly categorized as either real-time or cookie-based. Real-time data includes the date of the request, the time of the request, the Web site from which the request originated, the advertising placement within the Web site, and the physical size of the advertising placement. Cookie-based data includes the geographic location, browser speed, and operating system of the computer system requesting the advertising message.

Based on these pieces of information, the TPAS selects an advertising message to transmit to the user's browser in response to the request, and serves the ad into the respective placement. The TPAS also records the data associated with the original ad request, as well as information on which advertising message the TPAS selected to transmit to the user.

When the user's browser receives the selected advertising message, it displays it within the Web page. If the user's browser requested several advertising messages, it displays each of them within the Web page.

Each displayed advertising message typically includes one or more links to Web pages of the pertinent advertiser's Web site. If the user selects or “clicks” one of these links in the advertising message, the user's browser de-references the link to retrieve the Web page from the advertiser's computer system. The browser then receives and displays the Web page on the user's computer screen. The TPAS records the click, and associates it with the user's anonymous cookie identification number.

Although a “click” is the typical user's approach for responding to Internet advertising, there are three other approaches. First, after “clicking” the advertiser message, the user may choose to immediately leave the advertiser's site and return at a later time by submitting the advertiser's URL to the user's Internet browser. Second, upon viewing the advertising message, the user may reach the advertiser's Web site without clicking on the advertising message, by submitting the advertiser's URL to the Internet browser. Finally, the user may not choose to “click” or to immediately visit the advertiser's site, but might choose to visit some time in the future, by submitting the advertiser's URL to the user's Internet browser.

Whatever the method of reaching the advertiser's site, during the user's visit(s) to the advertiser's Web site, he/she may perform a transaction that the advertiser has agreed to pay the publisher for causing through advertising messages as part of a performance deal. Such a transaction might include a purchase, a registration, or an e-mail address submission. Moreover, the user might traverse several pages in the process of performing a given transaction. The Web page that he/she downloads to complete the transaction includes a request to the TPAS ad server for a tiny, invisible image, or pixel.

The function of this pixel request is to enable the TPAS to record the user's completion of the transaction and associate it with the anonymous cookie identification number that clicked on the advertising message, so that the publisher can bill the advertiser for the transaction. Upon receiving the request, the TPAS records the transaction and associates it with the browser's anonymous identification number. The TPAS then returns a tiny, invisible image to the user's browser. Although the browser displays the pixel on the user's computer screen, the image is visually undetectable.

After recording the transaction, the TPAS determines whether it can assign credit for causing the transaction to the advertising message that the user viewed and/or clicked. Critical to this process are the click and view windows. The click window defines the length of time after a user clicks an advertising message on the publisher's site during which transactions on the advertiser's site can be credited to the click. For example, if a user clicks on an advertiser's message on the publisher's Web site and transacts with the advertiser 30 days later, the advertising message receives credit for causing the transaction as long as the click window is 30 days or longer.

If the advertiser has agreed to pay for transactions that occur after the viewing of an advertising message, in the absence of a click, the view-window defines the number of days after a user views the advertising message during which a transaction can be credited to the view. For example, if a user views an advertiser's advertising message, does not click, and transacts with the advertiser 10 days later, the view receives credit for the transaction as long as the view window is 10 days or longer.

In general, the optimization system is designed to enable a publisher to manage multiple performance deals across large numbers of advertising placements. For example, a large publisher might manage more than 150 deals at a time, across over 1000 placements.

A performance deal is a pricing structure for Internet advertising inventory. Pricing for advertising can be broadly divided into two categories. The first is impression-based pricing, wherein the publisher sells an advertiser a number of impressions in a given time period. Impression-based pricing is typically done on a CPM basis, or cost per 1000 impressions.

Although publishers prefer impression-based pricing, market forces often prevent them from successfully selling all of their inventories under this structure. In general, the Internet advertising market sees a constant over-supply of impressions, given the accompanying demand. Therefore, on a monthly basis, most publishers have between 15% and 70% of impressions that cannot be sold through CPM pricing.

This market dynamic gives rise to a second pricing approach called performance-based pricing. Under this model, the publisher provides impressions for free, and the advertiser agrees to pay the publisher based on the success of the impressions in causing valuable advertiser results. This pricing structure is known as a “performance deal.” Typical examples of performance deals include cost-per-click, where the advertiser pays a bounty each time a user clicks on its advertisement; cost-per-sale, where the advertiser pays a bounty each time a user clicks on an advertisement on the publisher's site and subsequently makes a purchase on the advertiser's Web site; and cost-per-registration, where the advertiser pays a bounty each time a user clicks on the advertiser's banner on the publisher's site, and subsequently completes a registration page or e-mail submission on the advertiser's site. Many permutations of these deals exist.

Publishers measure the value of performance deals by effective CPM (eCPM). The eCPM is calculated by multiplying the revenue generated from a particular deal by 1000, and dividing the product by the impressions required to generate the revenue. By way of example, if a publisher granted an advertiser 1,000,000 impressions, generated 50 valuable transactions, and the advertiser agreed to pay $50 per transaction, that advertiser's eCPM would be calculated by: 50*50*1000/1,000,000=$2.50. The eCPM provides a useful metric for appraising the effectiveness of performance deals, and for comparing the value of performance deals with impression-based deals. eCPM calculations are also useful for comparing the revenue-generating capability of different advertising placements within a given Web site.

The optimization system creates value for the publisher through two distinct systems—a technology system and an information system. The technology system maximizes the revenue generated by each of the publisher's placements in four steps. First, the system analyzes each advertiser's performance on each of the publisher's advertising placements, on a placement-by-placement basis. Second, the system estimates the future performance of each advertiser on each placement. Third, the system allocates advertising inventory on each placement to those advertisers that provide the highest probable revenue. Finally, the system configures user-level variables to maximize expected revenue from each user exposed to advertising.

This technology system provides two key benefits for the publisher. First, the advertisers whose performance deals provide the most revenue for the publisher receive the highest inventory volumes and the highest numbers of incremental transactions. Therefore, because the volume attributed to each deal is dependent on the relative performance of its advertising, the risk of the advertising performance returns to the advertiser and the publisher's exposure to the risk of the advertiser's effectiveness is significantly reduced. The second benefit is that the revenue generated by each placement, or the average eCPM for each placement, rises significantly, because the most lucrative performance-based advertisers are constantly allocated the bulk of the inventory on each placement.

The information system provides reports to both the advertisers and the publisher, each with a different objective. Advertiser reports are designed to advise each advertiser on how to make its advertising perform more effectively, so that the advertiser can merit more advertising inventory—and therefore incremental transactions—through the optimization. For example, reports detail how changes in advertising messages, bounties per transaction, or changes in the click or view window will make each advertiser's deal performance change.

The advertiser reports enable the publisher to create an optimization-based auction environment for its advertising inventory by pitting them against each other. Using the advertiser reports, the publisher can identify advertisers whose products and services match well with the publisher's audience and push each of them to their maximum willingness to pay for transactions.

The publisher reports provide performance information for each deal, as well as comparisons of placement performance. Publisher reports that compare advertiser performance enable the publisher to quickly learn what types of deals and deal structures work best for the publisher's web site, informing both sales and negotiation activities.

The information on the relative performance of placements enables the publisher to make informed decisions on how to modify or adjust placements to enhance their performance for all advertisers. The publisher may also, based on the publisher reports, decide to retire certain placements whose performance is unacceptable. Both of these benefits allow the publisher to raise the revenue generated by the publisher throughout the site.

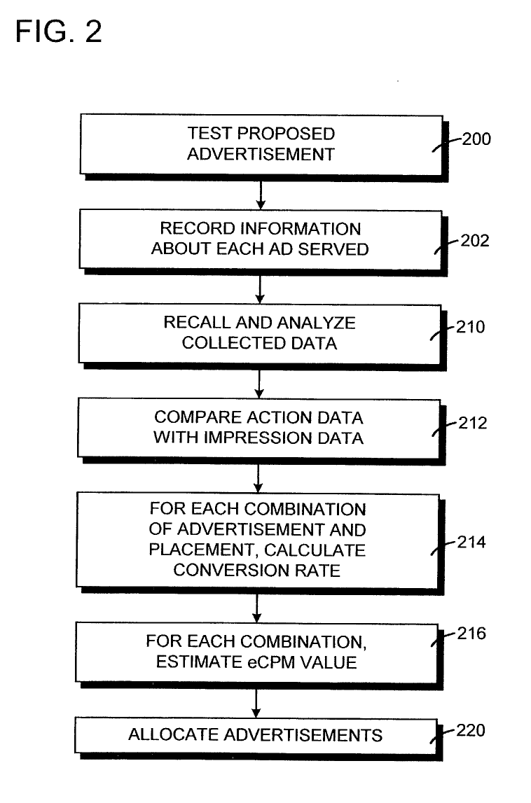

The system, once implemented, operates as shown in FIG. 2. The system is designed so that a team of people (optimization team) operates the optimization system, and coordinates with publisher personnel to ensure smooth integration with the publisher's operations. Implementation of the system is somewhat complex, and requires several steps.

First, the publisher must configure its publisher advertising system to send advertising inventories to the TPAS. In a typical implementation, the publisher selects advertising placements on its Web site that yield substantial amounts of non-CPM inventories on a monthly basis. In other words, the publisher selects those placements that are commonly used for performance inventory to be managed by the optimization system.

Second, for each of those placements, the publisher implements “re-directs” into its Publisher advertising system. “Re-directs” are pieces of HTML code that receive requests for advertising messages and send them to another computer system. In this case, the re-directs are configured to send requests for advertising messages from the publisher system to the TPAS. In a typical implementation, one re-direct is implemented for each placement, but several configurations are possible The publisher advertising system is configured to distinguish between advertising requests for inventory that has been sold on a CPM basis, and those which have been sold on a performance basis. The inventory sold on a performance basis, then, can be sent to the TPAS.

Third, the optimization team configures the TPAS to receive the requests coming from the publisher advertising system, to record pertinent data (as described above), and to select an advertising message to return to the publisher advertising system.

Fourth, the publisher sends several pieces of information concerning the performance deals currently running on the publisher's non-CPM inventory to the optimization team, to allow the team to set up the performance deals in the optimization system. These include, but are not limited to, the agreed-upon bounty per transaction that the advertiser pays the publisher per their respective deal; advertiser budget limits; agreed-upon impression minima or maxima; agreement start and end dates; and placements where specific publishers have “opted-out,” or refuse to run their advertisements. The publisher also forwards the electronic advertising messages for each advertiser to the optimization team. Upon receiving the advertising messages and deal-specific information, the optimization team submits both the information and the messages to the optimization system.

Fifth, advertisers who have agreed to pay for transactions that occur on their Web sites as a part of their performance deals install action tags on their Web sites, in order to allow the TPAS to record the transactions. The optimization team creates the action tags and forwards them to the Publisher, who forwards the tags to the advertiser. Once the advertiser has implemented the action tags on appropriate pages that enable the TPAS to record the transactions, the optimization team ensures that the tags are collecting data appropriately.

Sixth, the publisher and the optimization team agree upon a testing period, during which the performance deals are tested, in order to collect performance data on each. In the case of a typical implementation, all ads are tested on all of the publisher placements, but the publisher can opt to omit particular advertisement/placement combinations from the test period.

As a part of the process of configuring the test period, the Optimization system calculates the percentage of the impressions on each placement that will be allocated to each of the advertisers, in order to collect sufficient data. In a typical implementation, the impression levels allocated to each agreement are similar (within 5% of one another). However, the optimization system may also allocate higher impression levels to specific deals, if it determines that higher impression levels will be necessary during the test period to collect sufficient data.

Once the deals have been set up in the system and the test period has been sufficiently configured, the publisher and the optimization team agree upon a date to begin re-directing non-CPM inventory from the selected placements in the publisher advertising system to the TPAS. From this date, for the duration of the testing period, the TPAS responds to each request for advertising messages with an appropriate advertiser message, following the allocation scheme configured by the optimization system.

During the test period, the TPAS records various pieces of data for each user request for and ad or an action tag. As stated before, these pieces of data can be broadly categorized as either real-time or cookie-based. Real-time data includes the date of the request, the time of the request, the Web site from which the request originated, the advertising placement within the Web site, and the physical size of the advertising placement. Cookie-based data includes the geographic location, browser speed, and operating system of the computer system requesting the ad or action tag. By collecting this data, the TPAS is able to build, for each performance deal, information necessary optimize each publisher placement.

At the end of the test period, the optimization system begins to optimize each placement of the publisher's inventory to maximize the revenue generated by each placement. The optimization process, in short, is a re-configuration of the decision-logic within the TPAS. During the test period, the TPAS decision logic is configured to allocate impressions relatively evenly across ads submitted for each performance deal. When optimized, the TPAS decision logic responds to requests for ads with those ads that maximize the revenue for the publisher. In other words, the goal of optimization is to configure the TPAS decision logic to respond to each request for an advertising message with that message that will maximize expected revenues from performance deals.

This process consists of five general steps. First, the optimization system extracts a compilation of the real-time and cookie-based data collected by the TPAS during the test period, along with information describing the current configuration of the decision logic within the TPAS. Second, based on the data collected during the test period, the optimization system calculates how many impressions should be allocated to each performance deal, on a placement-by-placement basis, in order to maximize the revenue generated by each placement. Third, based on these allocations, the optimization system determines how many impressions for each deal should be allocated to each advertising message within each respective deal. Fourth, based on these calculations, the optimization system determines how each specific advertising request should be handled within the deal-level and message-level allocations, by incorporating cookie-based data collected during the test period. Finally, based on the results of this process, the optimization system creates a new configuration for the TPAS decision-logic and submits it to the TPAS. The TPAS decision-logic, and therefore the publisher's inventory, is thereby “optimized.” Each of these steps is described below.

The first step is the extraction of real-time and cookie-based data from the TPAS. At its most basic level, the TPAS collects and stores value in log-file form, without calculations to make the data meaningful or useful. However, the TPAS incorporates a procedure known as ROI processing, through which it transforms real-time data into calculations that are useful for making decisions. In short, the real-time data collected by the TPAS, after ROI processing (performance data), consists of impressions, clicks, and transactions “credited” to advertising. Moreover, these pieces of data are segmented and can be analyzed by advertising message, advertiser, publisher placement, or any combination of the three.

To begin making calculations, the optimization system downloads the performance data from the TPAS. Typically, four weeks' data is used. However, the interval of data can be adjusted, either in aggregate or by advertiser or placement, when more accurate decisions are possible. The data interval is configured by the optimization team.

Cookie-based variables, such as frequency per user, geographical locations of users, and age/gender of users are also tracked in raw form as log files in the TPAS. These log files go through customized calculations before being compiled into a form that is useful for making decisions (user data). This user data is also downloaded to the optimization system. Further, the data interval is also specified and configured by the optimization team.

The TPAS also submits the current decision logic for handling ad requests on each publisher placement to the optimization system. When the optimization system successfully downloads the performance data, the user data, and the decision logic data, it is ready to begin making calculations and re-allocation recommendations to the TPAS.

The second step is the calculation of optimal allocations of advertising inventory, on a placement-by-placement basis, to those deals running on each placement, to maximize expected revenue for the publisher. This process consists of two general calculations. The first calculation is the estimation of expected revenue for every deal on every placement. The metric used for this calculation is eCPM.

To calculate eCPM, the optimization system performs the following process. First, for each placement, the system checks to see if it has collected enough data to make statistically significant—our unlikely to change significantly over time—eCPM estimates for one or more deals on the given placement. The required data to make statistically significant estimates on each placement is the result of experience and research on the part of the inventor, and remains a configurable setting in the optimization system. By way of example, the optimization system may be configured to verify that at least one performance deal on the given placement has caused at least 15 transactions before making an eCPM estimate for that performance deal on that particular placement, because 15 transactions is considered the minimal number of transactions required to calculate an eCPM estimate with confidence that it will not change significantly from period to period. If statistically significant data does not exist for any advertiser on the placement, the optimization system does not estimate the eCPM for any advertiser using data from that placement alone. The “rollup” process employed by the Optimization system for handling this scenario is described below.

If the optimization system is able to estimate eCPM for at least one performance deal on the placement, it then surveys the deals on the placement without statistically significant data in order to identify any performance deals that it can identify as “known bad.” A performance deal on a given placement is considered “known bad” if the probability that the performance deal, when it reaches the point of statistically significant data, will merit impression allocations is remote. For example, if a given Performance deal has accrued a large amount of impressions, but still has not generated a sufficient number of transactions to merit a statistically significant eCPM estimate, the optimization system will conclude that the performance deal is a “known bad” and automatically disqualify it for impression allocation on the placement.

Finally, for all other deals, the optimization system arrives at eCPM estimates using a “rollup” process. These deals include those that are not currently running on the placement (if any), and those that are running, have yet to accrue statistically significant data, but are not “known bad.” To perform a “rollup” estimate, the optimization system combines the data from the placement in question with data from other placements where the performance deal is also running, in order to increase the amount of data available for the eCPM estimate. The optimization system often discounts “rollup” eCPM estimates to some degree, to reflect the fact that they are not the exclusive result of data from the specific placement in question. However, inventor research has shown that properly performed “rollup” eCPM estimates are reasonably accurate, when statistically significant data does not exist for a specific Performance deal on a specific placement.

The second calculation, again performed on a placement-by-placement basis, is the appropriate impression allocation to reward to each performance deal on each placement, given the eCPM calculations described above. Three factors are important in making this calculation. The first factor is the impression forecast for each placement in the publisher's Web site. To estimate the impressions available for optimization in the current period, the optimization system uses the performance data to calculate a delivery forecast for the coming period. These impressions, then, are allocated in subsequent steps across advertisers on a placement-by-placement basis.

The second factor is the “saturation effect” of increasing impression levels on a given performance deal. Research has shown that allocating additional impressions to a performance deal on a given placement drives down the eCPM of the deal on the placement. Although this phenomenon occurs for many reasons, the major factor is the fact that additional impressions do not always reach additional users; instead, the bulk of impressions are actually viewed by a small number of viewers. Therefore, as impression levels rise for a particular Performance deal on a particular placement, the probability that the users reached by the additional impressions will transact with the advertiser drops. This phenomenon is broadly known as the “saturation effect.” For example, a performance deal on a given placement whose eCPM estimate is $0.50 at 5 MM weekly impressions can drop to $0.20 when escalated to 20 MM weekly impressions, simply due to “saturation.”

Therefore, the need exists to estimate this “saturation effect” for each deal on each placement when making impression allocation decisions, in order to ensure that each performance deal receives an appropriate amount of impressions. For example, if the best performance deal running on a given placement has an eCPM of $0.50, and the second best deal has an eCPM of $0.40, the best decision to make is to reward the $0.50 Performance deal until the “saturation effect” of the additional impression drives the eCPM of the deal to the $0.40 level, at which time both deals should receive impressions, and so on.

To accomplish this tradeoff, the optimization system generates saturation curves to guide its impression allocation decisions. Saturation curves estimate the users reached at various impression levels, and therefore serve as rough predictors of the diminishing impact of additional impressions on each Performance deal's eCPM. Therefore, for each placement, each performance deal not only receives an eCPM estimate for its current impression level, but also receives estimates of its eCPM for several impression levels, both higher and lower, on the placement.

The third factor is the level of certainty around the eCPM estimates calculated on each placement. The optimization system considers eCPM estimates that are made with statistically significant placement data to be more “certain” than estimates made through a “rollup” process. Therefore, the optimization system places allocation restrictions around Performance deals whose eCPM estimates are less “certain.”

To make the impression allocation decisions, the optimization system takes the impression forecasts for each placement, any minimum or maximum impression levels set up in the optimization system as a part of the deal, eCPM estimates, saturation curves, and certainty levels for each Performance deal on each placement and submits them to an off-the-shelf linear programming software. The current embodiment uses Dash Optimization Software, but many suitable alternatives exist in the marketplace. The linear programming software, using the information submitted to it, provides the optimal allocation of impressions from each placement to each Performance deal, and exports the results to the optimization system database.

The third step in the process may be referred to as “creative optimization.” In short, the optimization system determines how it should divide the impressions allocations for each performance deal between the advertising messages attached to each deal. For example, if the optimization system determines that a given performance deal should receive 20 MM impressions in a given week, and the advertiser represented by the performance deal has submitted 5 advertising messages to the publisher, the optimization system determines how to best allocate the 20 MM impressions across the 5 advertising messages in order to maximize the revenue generation of the performance deal.

The creative optimization calculations are similar to those described above for placement optimization. For each placement, the optimization system attempts to estimate eCPM for at least one of the ads using statistically significant data. Those ads whose eCPMs can be successfully estimated receive additional impression allocations commensurate with their performance. In the example above, if the eCPMs for two ads can be estimated at $0.50 and $0.40, the first ad might receive 10 MM impressions, and the other might receive 8 MM impressions. All other ads receive a much lower number of the impressions on the placement (in the above example, they would evenly divide the remaining 2 MM impressions).

Fourth, the optimization system leverages cookie-based data to determine how to best allocate, within the performance deal and ad impression allocations, each specific request for an advertising message to maximize the expected revenue from each impression. Although this part of the process is more difficult to explain, one example of the process is controlling the frequency exposure per user. The optimization system may elect to limit, on each given publisher placement, the number of exposures to a given advertiser's messages at the user level. For example, the optimization system may determine that, on a given placement, that each user's browser should only be able to view each of a given advertiser's ads once, because additional exposures on that placement yield lower expected revenues.

In this case, the optimization system estimates the impact of imposing user-level frequency caps on the impression allocations calculated before. In other words, by imposing a user-level frequency cap, the optimization system must now estimate, given the unique characteristics of each placement, how many impressions will actually be necessary to reach the impression allocation calculated in step two, when user-level frequency caps are in place. Based on these calculations, the optimization system adjusts the impression allocations to performance deals and to ads within the deals, to more accurately reflect probable delivery levels.

The final step of the optimization process is to re-configure the decision logic used by the TPAS to respond to requests for advertising messages. To do this, the optimization system translates the impression allocations on each placement to each performance deal, the impression allocations to each ad within each respective deal, and the impacts of cookie-level rules and converts them to a set of decision logic interpretable by the TPAS. The optimization system uploads the new decision logic to the TPAS, and the publisher's inventory is “optimized.” As requests for ads arrive from the publisher advertising system, the TPAS uses the optimized decision logic to determine which ad from which advertiser to return to the publisher advertising system, thereby maximizing the expected revenue from the publisher's non-CPM inventory.

Once the optimization process is complete, the optimization system creates several reports. The reports are broadly divisible into two categories: advertiser reports and publisher reports. The goal of advertiser reports is to arm advertisers with performance deals running on the publisher's Web site with information necessary to improve the eCPMs of their respective deals, thereby meriting more impressions (and therefore more transactions) on the publisher's Web site.

The first report is the Advertiser Creative Performance report. For each ad submitted by a given advertiser to the publisher, the report details the attributable impressions, clicks, and transactions. This allows advertisers to make comparative judgments between Ads that are currently running in the program, as well as develop qualitative knowledge about which types of creative are most effective at driving revenue. To develop the Advertiser Creative Performance report, the optimization system pulls performance data from its database and compiles it into an electronic report, which may be rendered in a spreadsheet format, such as Microsoft Excel, or displayed using a Web-based environment.

The second report is the Bid Guide. As mentioned before, the performance of each advertiser's performance deal is intimately tied to the bounty it has agreed to pay for each transaction driven by the publisher's advertising placements, and most advertisers strike performance deals with publishers at bounties much lower than those that would otherwise make sense for their businesses. Therefore, the goal of the Bid Guide is to provide advertisers with information concerning the likely impact on the performance on their respective performance deals of increasing their bounties by various increments. The Bid Guide displays, for several incremental bounty increases, the likely impressions, clicks, and transactions that the advertiser could expect after a subsequent optimization. The Bid Guide is the innovation that enables the publisher to transform its non-CPM inventory into an optimized auction environment, returning the risk of deal performance back to the advertiser, and constantly challenging the advertisers to take steps to increase the performance of their respective deals.

To generate the Bid Guide, the optimization system literally re-runs the optimization routine described previously several times. For each advertiser, the optimization system “plugs in” various bounty increments and re-runs the optimization routine, and records the impressions that the optimization system would have allocated to the advertiser at its new bounty level. The optimization system also calculates, using the performance data extracted from the TPAS, the incremental clicks and conversions that would likely result from the new impression allocations. This data is stored in the optimization system database, and then compiled into a report that can be rendered in a spreadsheet environment such as Microsoft Excel, or displayed in a Web-based environment.

The optimization system also generates two publisher reports that are useful for making decisions. The first publisher report is the Inventory Evaluation Report. For each publisher placement, this report details the impressions, clicks, and actions driven for all advertisers, as well as the eCPM generated by the placement, during a given period of days. This report is useful because it allows the publisher to compare the revenue generating effectiveness of each of the placements on its Web site, and to develop qualitative learning concerning the types of inventories, placements, and audiences that are most effective at driving revenues. To develop the Inventory Evaluation report, the optimization system pulls performance data from its database and compiles it into an electronic report, which may be rendered in a spreadsheet format, such as Microsoft Excel, or displayed using a Web-based environment.

The other publisher report is the Deal Evaluation report. Similar to the Inventory Evaluation Report, this report shows the impressions, clicks, and transactions associated with each performance deal running on the publisher's Web site. The Deal Evaluation Report is useful because it allows the publisher to make quantitative comparisons between performance deals, and to develop qualitative learning concerning which types of deals are most effective in generating revenue on the publisher's Web site. To develop the Deal Evaluation report, the optimization system pulls performance data from its database and compiles it into an electronic report, which may be rendered in a spreadsheet format, such as Microsoft Excel, or displayed using a Web-based environment.

After the initial optimization of the publisher's inventory, new Performance deals can be submitted to the optimization system, and set up in the TPAS for data collection. The optimization system continues to re-optimize the publisher's inventory on a periodic basis, and new deals are tested and eventually become a part of the optimization process as well. Here begins the ongoing partnership between the publisher and the optimization team in earnest, as the publisher is now armed with new negotiating leverage and information that fundamentally changes its positioning with advertisers.

When an advertiser approaches a publisher who is managing its performance deals with the optimization system to strike a performance deal, the publisher initially leverages the Deal Summary and Inventory Evaluation reports to inform the up-front negotiation. By comparing the advertiser's business and offering with those already in the system, the publisher can predict the performance of the advertiser before striking a deal. Then, based on the current eCPM throughout its Web site, the publisher can advise the advertiser on the bounty per transaction likely required to receive advertising inventory after optimization. If the advertiser is unwilling to pay the requested bounty per transaction, the publisher can walk away from the negotiation.

If the publisher and advertiser successfully strike an agreement, the agreement is submitted to the system. First, the advertiser submits advertising messages to the publisher, who forwards them to the optimization team. Second, the publisher communicates the deal type (e.g. cost per click, cost per sale, etc.) and pricing terms established with the advertiser to the optimization team. Third, in cases where the agreement calls for minimum or maximum impressions levels per week or month, regardless of the recommendations of the optimization system, the optimization team establishes these limits in the system. Fourth, the publisher forwards an action tag to the advertiser for submission on a page appropriate for tracking the agreed-upon transactions. Finally, if there are Web pages or placements within the publisher's Web site where the advertiser is not allowed to place advertising messages, the optimization team opts the advertiser out of those placements in the optimization system.

After the agreement is submitted to the system, a test period is established for the advertiser, in order to collect performance data for the advertiser across all advertising placements in a fashion identical to the initial test period. The optimization system uses analytical methods to determine the appropriate number of impressions on each placement to allocate to the advertiser in order to make statistically significant optimization decisions at the end of the test period.

During a subsequent optimization, the test period for the advertiser begins. When the optimization system generates impression allocations for deals that are currently running (i.e. not testing), it combines these allocations with the test impression allocations necessary for new deals that have been set up in the optimization system. From there, the TPAS decision logic is configured to accommodate both the optimization results for existing deals, and the allocation of test impressions for new deals. When the decision logic is uploaded to the TPAS, the new deals begin accruing impressions, and the TPAS begins collecting performance data on the new Performance deals.

During the test period, the system generates Bid Guides that predict whether the advertiser will be able to merit impressions during optimization, when the test period ends. If the system predicts that the advertiser will not successfully merit impressions during optimization, the publisher can advise the advertiser on how to improve the performance of its advertisements before the end of the test period. Possible approaches might include raising the advertiser's bounty per transaction, elongating the click or view window, changing offerings, or changing advertising messaging.

When the test period for a given performance deal ends, the deal's allocation of impressions for testing is removed and the deal must rely on its performance data to compete with existing deals in the optimization “tournament.” To the extent that the performance of the deal, optimized on a placement-by-placement basis with other deals running on the publisher's Web site, merits impression allocations by the tool, the deal receives impression volume. However, if the deal's performance does not fare well against existing deals on each placement, it loses impression volume quickly. Deals that perform well in general can often gain impressions on several placements, and thereby build significant impression volume quickly. However, deals that perform poorly in general often lose impressions on most of their placements, and are often therefore removed from the optimization system altogether.

Through a process of introducing new deals, continually optimizing the existing publisher inventory, and providing Bid Guides to advertisers, the publisher perpetuates an optimization/auction environment for its performance inventory. Advertisers are constantly motivated to take steps to improve the performance of their deals by making changes to their deals, such as submitting new ads, increasing their bounties per transaction, elongating the click or view windows, or accepting view-based conversions.

When an advertiser decides to change its deal terms or to submit new ads to the optimization system in an attempt to improve the eCPM of its performance deal, it forwards the changes/additions to the publisher, who forwards them to the optimization team. The optimization team submits the changes/additions to the optimization system, and they are implemented at the next available optimization.

1. A method of determining the placement of a plurality of different Internet advertisements at a plurality of different Internet publisher websites sites each having an advertisement placement space, comprising:
for each user visiting a publisher website, serving an impression of an advertisement;
recording initial web browsing activity data for each impression served;
recording subsequent action data associated with the service of the impression;
associating the subsequent action data with the initial web browsing activity data to generate an effectiveness level for at least a plurality of the combinations of advertisements and placement spaces;
based on the generated effectiveness levels, distributing serving of the advertisements among the placement spaces.

2. The method of claim 1 wherein recording initial web browsing activity data includes recording a unique identifier associated with the user and recording information identifying an advertisement impression served.

3. The method of claim 1 wherein recording subsequent action data includes recording information about at least one of the set of actions comprising clicking on an advertisement, participating in a communication of information desired by the advertiser, and engaging in a commercial transaction.

4. The method of claim 3 wherein associating the subsequent action data includes recording a unique identifier associated with the user upon recording initial web browsing activity data and recording the unique identifier upon recording subsequent action data.

5. The method of claim 1 wherein distributing serving of the advertisements includes calculating, for each combination of advertisement and placement spaces at which the advertisement was served, an effectiveness ratio of subsequent action data to initial web browsing activity data.

6. The method of claim 5 wherein calculating an effectiveness ratio includes basing the effectiveness ratio on a price per subsequent action.

7. The method of claim 1 wherein distributing serving of the advertisements includes calculating, for each combination of advertisement and placement spaces at which the advertisement was served, an effectiveness ratio of desired actions taken to impressions served.

8. The method of claim 1 wherein distributing serving of the advertisements includes operating a linear program software operable to approximate a maximum advertising effectiveness.

9. The method of claim 1 including periodically reallocating distribution of advertisements based on ongoing updating of recorded data.

10. A method of conducting Internet advertising transactions comprising:
conducting a test advertising run of a plurality of advertisements distributed among a plurality of publisher advertising placement spaces;
based on the test run, determining the number of impressions served to users and the number of other desired actions undertaken by users for at least some of the combinations of advertisements and placement spaces;
establishing a price bounty per other desired action;
based on the price bounty, the number of impressions served, and the number of other actions for at least some of the combinations, allocating advertisements to placement spaces.

11. The method of claim 10 including basing the price bounty on the expected number of expected actions per impression.

12. The method of claim 10 wherein allocating advertisements includes operating a linear program software operable to approximate a maximum advertising effectiveness.

13. The method of claim 12 wherein the maximum advertising effectiveness is based on the total revenue expected from the price bounties generated.

14. The method of claim 10 wherein the other actions includes at least one of participating in a communication of information desired by the advertiser, and engaging in a commercial transaction.

15. The method of claim 10 including periodically reallocating advertisements based on ongoing updating of recorded data.

16. The method of claim 10 including determining if, for a given advertiser, a subsequent action is associated with an advertising impression by recording a unique identifier associated with the user in conjunction with the action and with the impression.

17. The method of claim 16 including calculating a time interval between the impression and the action, and if the interval is less than a predetermined threshold, determining that the impression is associated with the impression.

18. The method of claim 17 including allocating advertisements based on the association between impressions and actions.
